(19) United States
(12) Patent Application Publication
(10) Pub. No.: US 2026/0352025 A1
(43) Pub. Date: Nov. 5, 2026

(54) UNIVERSAL WIRELESS CHARGING STATION FOR UNDERWATER ROBOTS AND VEHICLES

(71) Applicants: Drexel University, Philadelphia, PA (US); University of Virginia Patent Foundation, Charlottesville, VA (US)

(72) Inventors: Fei Lu, Wynnewood, PA (US); Yao Wang, Philadelphia, PA (US); Joseph Jianzhong Zhu, Crozet, VA (US); Hilary Bart-Smith, Glen Rose, TX (US)

(73) Assignees: Drexel University, Philadelphia, PA (US); University of Virginia Patent Foundation, Charlottesville, VA (US)

(21) Appl. No.: 19/486,744

(22) PCT Filed: May 24, 2024
(86) PCT No.: PCT/US2024/030941

§ 371 Date: Nov. 21, 2025

Related U.S. Application Data
(60) Provisional application No. 63/505,897, filed on Jun. 2, 2023.

(51) Int. Cl. H02J 50/12; B60L 53/126; H02J 50/00; H02J 50/90

(52) U.S. Cl. CPC H02J 50/12; B60L 53/126; H02J 50/005; H02J 50/90; B60L 2200/32

(57) ABSTRACT

A wireless charging station installed on the seafloor is equipped with multiple wireless transmitter coils and powered by a large-capacity lithium-battery-based energy storage system (ESS). Correspondingly, small-size wireless receiver coils are installed inside underwater robots and vehicles. When the battery is low in the underwater devices, the robots and vehicles automatically swim to the charging station and land in a specific charging region. After identifying the robots and vehicles, the wireless charging station can automatically start a wireless charging operation.

### BACKGROUND

Inductive power transfer (IPT) technology is becoming an attractive charging solution for underwater vehicles and robots as it gets rid of troublesome cables and avoids frequent battery replacement operations, demonstrating a more convenient and safer charging pattern.

FIG. 1 shows an underwater inductive charging scenario aimed at underwater manta ray robots 100. Based on the body shape of the manta ray robots 100, planar receiver coils 110 can be installed into the robot body and the transmitter 130 can be deployed on the sea floor. In this case, a lightweight and small-size and compact receiver assembly is preferred, and the IPT system is expected to have high misalignment tolerance for a large effective charging region.

Due to the high circuit simplicity and good compatibility with battery charging, series-series (SS) IPT topology is a possible battery charging candidate. However, in the conventional resonant SS IPT system, the charging power significantly increases with the reduction of mutual inductance caused by misalignment, which can result in overpower and overcurrent charging issues at a weak magnetic coupling condition. In the worst case of zero coupling between the transmitter and receiver, a series LC resonant short-circuit will be triggered on the transmitter side, causing a high fault current that can damage the system circuit. To address these concerns, a high-order LCC-LCC IPT circuit has been previously proposed, which achieves constant transmitting current in which the transmitter side can safely operate alone without coupling to the receiver. However, considering the limited space inside the manta ray robot, the high circuit complexity and system size make the LCC-LCC topology less attractive. Besides, high misalignment tolerance is always desired in inductive charging scenarios, which means the charging power keeps stable or only fluctuates slightly when a large misalignment occurs, which allows high charging flexibility and convenience. Some control strategies, such as phase-shift, voltage tuning, and capacitance tuning, have been previously proposed to achieve high misalignment tolerance. However, these strategies highly rely on dual-side communication, as shown in FIG. 2, which makes the whole system complicated and the communication is easy to be interfered by the magnetic field of the magnetic coupler.

Thus, there is a need for improved underwater wireless charging systems and methods.

### SUMMARY OF THE EMBODIMENTS

The present disclosure presents improved underwater wireless charging systems and related methods for underwater applications. In various embodiments, a wireless charging station is installed on the seafloor, which is equipped with multiple wireless transmitter coils and powered by a large-capacity lithium-battery-based energy storage system (ESS). Correspondingly, small-size wireless receiver coils are installed inside underwater robots and vehicles. When the battery is low in the underwater devices, the robots and vehicles automatically swim to the charging station and land in a specific charging region. After identifying the robots and vehicles, the wireless charging station can automatically start a wireless charging operation. Further, the ESS of the charging station can also be wirelessly recharged by submarine ships. Thus, in accordance with embodiments of the present disclosure, an exemplary wireless charging system provides a convenient underwater recharging solution for underwater vehicles/robots that do not require them to be recovered from the water. Additionally, it shows compatibility with various vehicles/robots with different body shapes and can simultaneously charge multiple devices, which achieves safe and automatic underwater charging operations, saving intensive labor forces and increasing the working efficiency of the underwater robots/vehicles.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an underwater inductive charging technique for manta ray robots.

FIG. 2 shows a general structure of an underwater inductive charging system for underwater applications.

FIGS. 3A-3B show external and internal views of an exemplary wireless charging station in accordance with various embodiments of the present disclosure.

FIG. 4 shows a system structure of an exemplary underwater charging system in accordance with various embodiments of the present disclosure.

FIG. 5 depicts a wireless power transfer from a submarine supply ship to a wireless charging station in accordance with various embodiments of the present disclosure.

FIG. 6 illustrates wireless charging scenarios from the submarine supply ship to the wireless charging station in accordance with various embodiments of the present disclosure.

FIG. 7 shows a system structure for a wireless power transfer from the charging station to underwater robots/vehicles in accordance with various embodiments of the present disclosure.

FIG. 8 shows wireless charging scenarios for multiple different underwater vehicles and robots in accordance with various embodiments of the present disclosure.

FIG. 9 shows a series-series inductive power transfer (SS IPT) circuit in accordance with various embodiments of the present disclosure and FIG. 10 shows an equivalent impedance circuit of the SS IPT circuit of FIG. 9.

FIG. 11 provides a chart showing maximum achievable system current and power versus |Z_{P}| for an exemplary SS IPT system of the present disclosure.

FIG. 12 provides a chart showing system power versus resistance R_{M} at specific Zₚ for an exemplary SS IPT system of the present disclosure.

FIG. 13 shows an image of an implemented magnetic coupler prototype in accordance with various embodiments of the present disclosure.

FIG. 14 is a chart showing the simulated coupling coefficient k versus horizontal misalignment for the magnetic coupler prototype of FIG. 13.

FIG. 15 is an image showing an implemented underwater SS IPT testing bench in accordance with various embodiments of the present disclosure.

FIG. 16 is a chart showing the calculated system power versus horizontal misalignment for the implemented underwater SS IPT testing bench of FIG. 15.

FIGS. 17A-17C provide experimental waveforms under saltwater at (A) no receiver with k=0; (B) 50-mm misaligned with k=0.147 and (C) well-aligned with k=0.243 for the implemented underwater SS IPT system in accordance with various embodiments of the present disclosure.

FIGS. 18A-18B display experimental output power pout versus (A) transfer distance and (B) horizontal misalignment for the implemented underwater SS IPT system in accordance with various embodiments of the present disclosure.

FIGS. 19A-19B display Experimental DC-DC efficiency versus (A) transfer distance and (B) horizontal misalignment for the implemented underwater SS IPT system in accordance with various embodiments of the present disclosure.

FIGS. 20A-20B shows a wireless charging circuit configuration of SS+SS, where FIG. 20A depicts an SS wireless charging circuit from submarine supply ship to the wireless charging station and FIG. 20B depicts an SS wireless charging circuit from charging station to underwater robots/vehicles in accordance with various embodiments of the present disclosure.

FIGS. 21A-21B show a wireless charging circuit configuration of LCC-S+SS, where FIG. 21A depicts an LCC-S wireless charging circuit from submarine supply ship to the wireless charging station and FIG. 21B depicts an SS wireless charging circuit from charging station to underwater robots/vehicles in accordance with various embodiments of the present disclosure.

FIGS. 22A-22B show a wireless charging circuit configuration of LCC-LCC+LCC-S, where FIG. 22A depicts an LCC-LCC wireless charging circuit from the submarine supply ship to the wireless charging station and FIG. 22B depicts an LCC-S wireless charging circuit from the charging station to underwater robots/vehicles in accordance with various embodiments of the present disclosure.

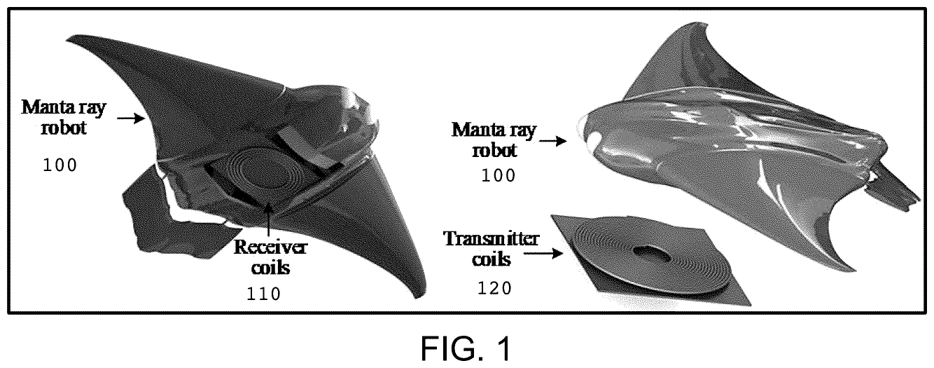

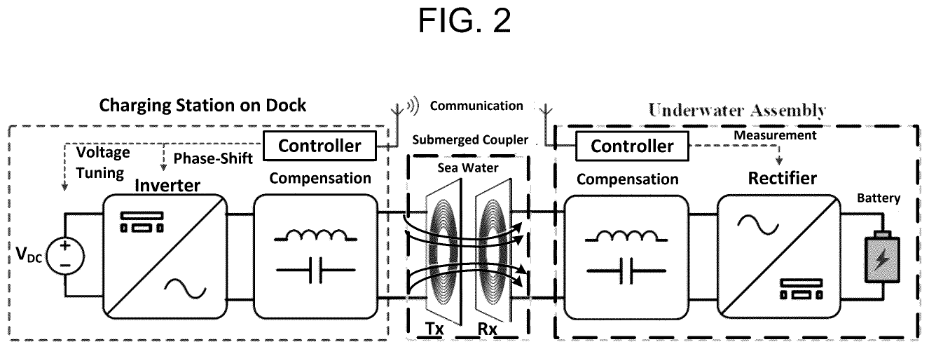

### DETAILED DESCRIPTION

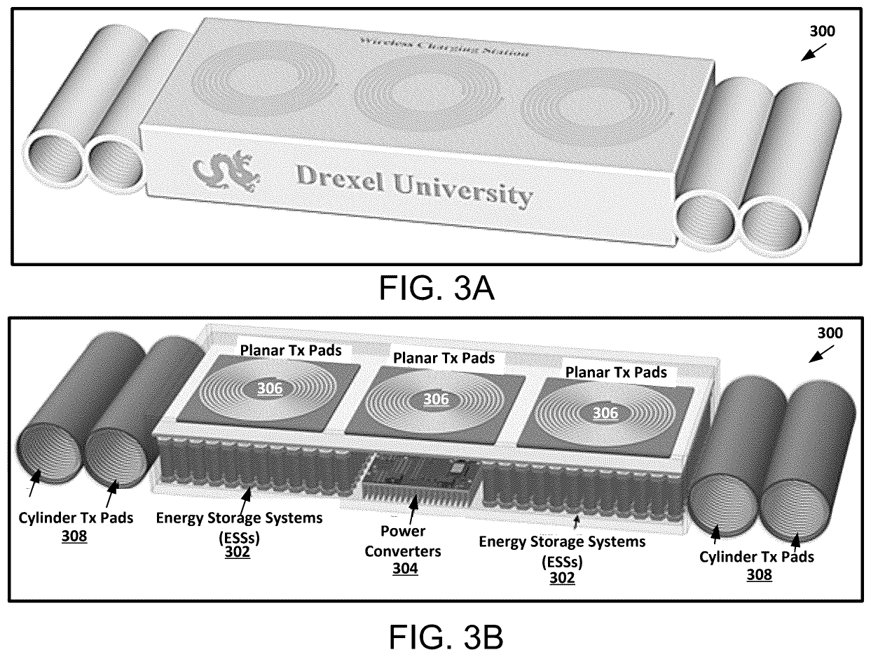

FIG. 3A demonstrates an external view of an exemplary underwater wireless charging station 300, where FIG. 3B presents the detailed structures inside the charging station 300. The wireless charging station 300 includes large energy-storage systems (ESSs) 302, power converters 304, and multiple transmitter (Tx) pads 306, 308. The multiple transmitters 306, 308 may be designed with different geometries, achieving universal compatibility with various vehicles/robots with different body shapes. For example, the planar transmitter (Tx) pads 306 are designed for charging the manta ray robot, and the cylinder Tx pads 308 may be used for autonomous underwater vehicles (AUVs) and fish robots.

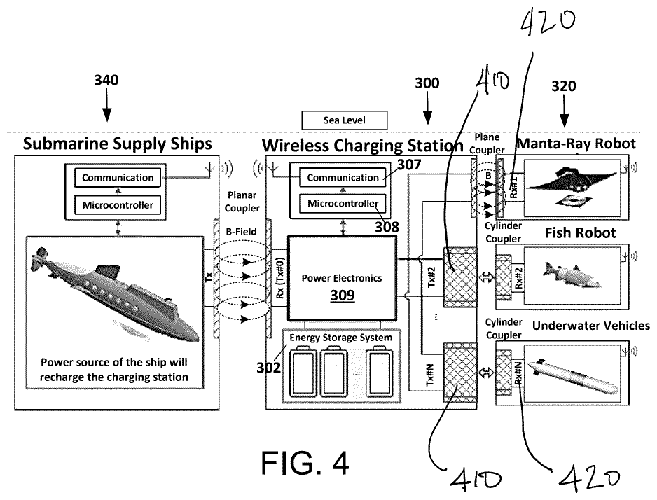

FIG. 4 shows an exemplary working procedure or arrangement of the wireless charging station 300. The wireless charging station 300 may be equipped with multiple transmitters (Tx #0~Tx #N) 410 and the underwater robots/vehicles 320 may be equipped with receiver pads (Rx #1~Rx #N) 420. The power can be wirelessly transferred between the transmitters of the charging station 300 and receivers 420 of underwater robots/vehicles 320 via the high-frequency alternating magnetic field. The wireless charging station 300 may simultaneously charge multiple different underwater robots/vehicles 320.

Meantime, the transmitter Tx #0 410 may also work as the receiver to obtain power from the submarine supply ships 340. The power electronic converter 307 may achieve constant-current (CC) and constant-voltage (CV) charging for both the ESSs and the battery of underwater robots/vehicles. The microcontroller 308 and communication circuitry 309 may provide intelligent and automatic charging/discharging operations, which save intensive labor forces and increases the working efficiency of underwater robots/vehicles.

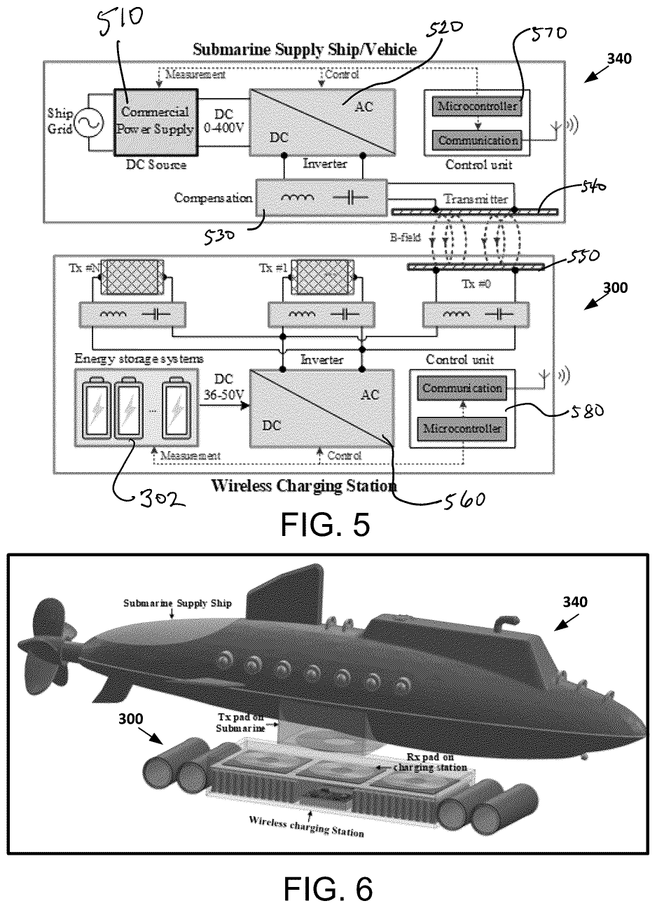

The power may be first wirelessly transferred from the submarine supply ship 340 to the charging station 300 and temporarily stored in the ESSs 302. FIG. 5 shows the detailed system design for wireless power transfer from the submarine supply ship 340 to the charging station 300 and FIG. 6 shows wireless charging scenarios from the submarine supply ship 340 to the wireless charging station 300.

In the submarine supply ship 300, a commercial DC power supply 510 may be connected to the ship grid and can provide a DC voltage of up to 400V. A DC/AC inverter 520 may be provided to function as the high-frequency AC power source. The compensation networks 530 may be used in double sides to cancel the reactive power generated by the transmitter and receiver coils 540. In operation, excited by a high-frequency current, the transmitter 540 will generate an alternating magnetic field. On the wireless charging station side 300, transmitter Tx #0 550 may be designed to receive power from the submarine supply ship 340 based on the electromagnetic induction principle. Then, a bidirectional DC/AC converter 560 works in rectification mode to achieve DC charging for the ESSs. Double-side control units 570, 580 with communication capabilities achieve intelligent and automatic charging operations.

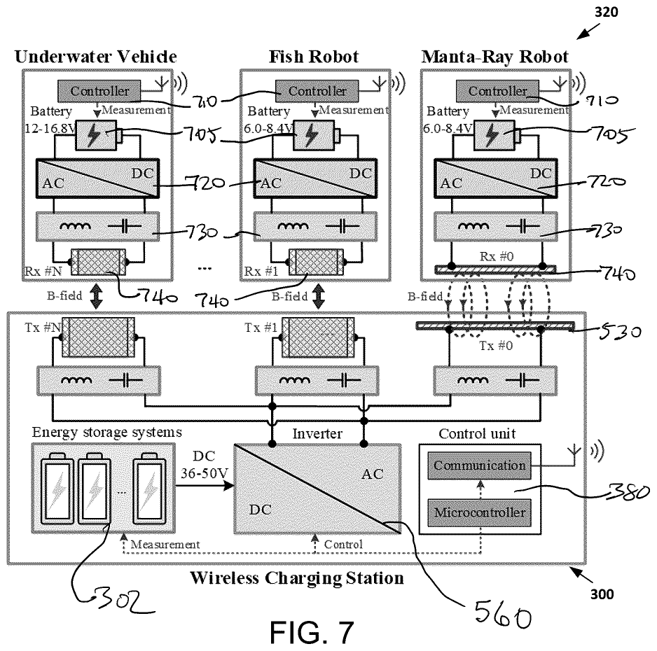

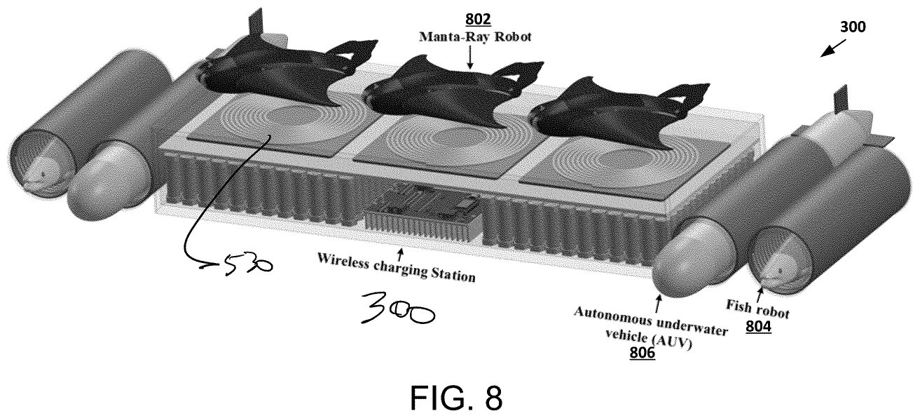

FIG. 7 shows the wireless charging system design from the charging station 300 (with a structure similar to that already shown) to underwater robots/vehicles 320, and FIG. 8 demonstrates wireless charging scenarios for robots having planar receiving coils (e.g., manta ray robot 802) and cylindrical receiving coils (e.g., fish robot 804, autonomous underwater vehicle 806). On the wireless charging station 300, the bidirectional DC/AC converter 560 works in inverter mode, which can simultaneously excite multiple transmitters 530. Each underwater robot/vehicle 320 is equipped with a receiver pad 740, compensation network 730, and an AC-DC rectifier 720 (connected to a battery 705). Double-side control units with communication capabilities 710 achieve intelligent and automatic charging operations. Multiple different underwater vehicles/robots 320 can be simultaneously charged. In an exemplary system, there are two wireless charging stages from the submarine supply ship 340 to the wireless charging station 300 and from the wireless charging station 300 to underwater robots/vehicles 320.

While inductive power transfer (IPT) technology is becoming an attractive charging solution for underwater vehicles and robots, the charging power significantly increases with the reduction of mutual inductance caused by misalignment, which can result in overpower and overcurrent charging issues at a weak magnetic coupling condition. In the worst case of zero coupling between transmitter and receiver, a short-circuit could be triggered on the transmitter side, causing a high fault current that can damage the system circuit. A detuned SS-compensated IPT system may achieve large inductive input impedance at weak and even zero coupling conditions and realize overcurrent and overpower protection. Meantime, an exemplary detuned SS compensated IPT system can achieve higher misalignment tolerance compared to the conventional resonant SS IPT system. To validate this design, a detuned SS IPT prototype was implemented with an input DC voltage of 150V and a 14.8V lithium-ion battery load and experimental results validate the overcurrent and overpower protection property and achieve a high misalignment tolerance.

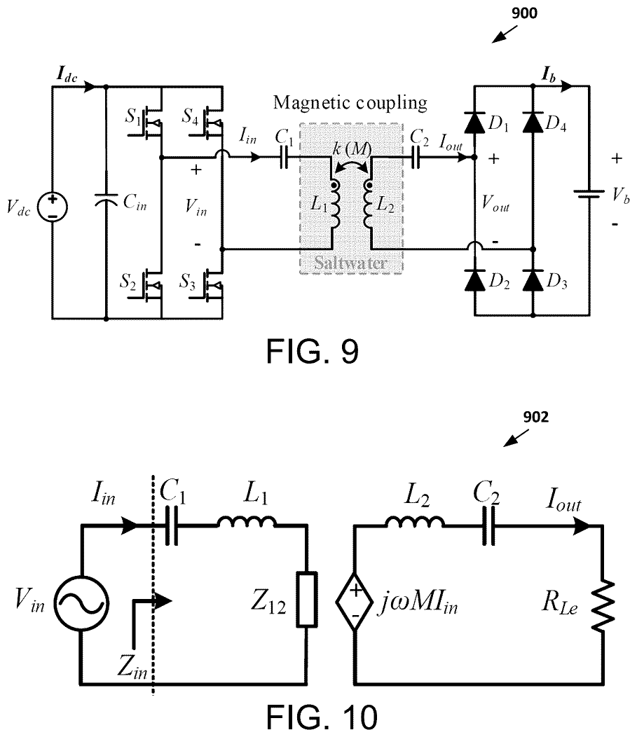

FIG. 9 shows an exemplary series-series compensated IPT circuit 900. L₁ and L₂ are the transmitter and receiver coils. C₁ and C₂ are series compensation capacitors. The mutual inductance is represented by M, and k is the coupling coefficient. V_{dc} is the input DC voltage and V_{b} is the voltage of the battery load. The equivalent AC load resistance is defined as R_{Le}, which is variable at different output currents Iₒᵤₜ. The system operating switching and angular frequency are defined as fₛ and ωₛ.

According to Kirchhoff's voltage law, the SS IPT system with a battery load is described in Equation (1) below. Iᵢₙ, Iₒᵤₜ, and R_{Le} are unknown and dependent on circuit parameters and Vin and Vout.

$$\{ \begin{matrix}{V}_{in} = {I}_{in} \cdot ( j {ω}_{s} {L}_{1} + 1 / j {ω}_{s} {C}_{1} ) - {I}_{out} j {ω}_{s} M \\ {V}_{out} = - {I}_{out} \cdot ( j {ω}_{s} {L}_{2} + 1 / j {ω}_{s} {C}_{2} ) - {I}_{in} j {ω}_{s} M \\ {V}_{out} = {I}_{out} \cdot {R}_{Le}\end{matrix} \qquad EQ . 1$$

The resonant frequencies of the transmitter and receiver sides are defined as f₁ and f 2, given below.

$${f}_{1} = \frac{1}{2 π \sqrt{{L}_{1} {C}_{1}}} , {f}_{2} = \frac{1}{2 π \sqrt{{L}_{2} {C}_{2}}} \qquad EQ . 2$$

The equivalent impedance circuit 902 is provided in FIG. 10. Impedance Z₁ and Z₂ are given below.

Z₁=jωₛL₁+1/(jωₛC₁),Z₂=jωₛL₂+1/(jωₛC₂) EQ. 3

according to Equations (1) and (3), the reflected impedance Z₁₂ and input impedance Zᵢₙ are provided as follows.

$${Z}_{12} = \frac{{( ω M )}^{2}}{{R}_{Le} + {Z}_{2}} , {Z}_{in} = {Z}_{1} + {Z}_{12} \qquad EQ . 4$$

In a conventional SS IPT design, both the transmitter and receiver circuits work in resonant conditions, namely, the switching frequency fₛ satisfies:

fₛ=f₁=f₂ EQ. 5

In this case, the impedances satisfy:

$${Z}_{1} = {Z}_{2} = 0 , {Z}_{in} = {Z}_{12} = \frac{{( ω M )}^{2}}{{R}_{Le}} \qquad EQ . 6$$

Then, currents Iᵢₙ and Iₒᵤₜ and output power Pₒᵤₜ are given as:

$${I}_{out} = - \frac{{V}_{in}}{j {ω}_{s} M} , {I}_{in} = \frac{{V}_{out}}{j {ω}_{s} M} , {P}_{in} = {P}_{out} = \frac{{V}_{in} {V}_{out}}{{ω}_{s} M} \qquad EQ . 7$$

According to Equations (6) and (7), the conventional resonant SS IPT system has the advantages of zero-phase-angle (ZPA) and load-independent CC output properties. However, it also shows that the input impedance Zᵢₙ is closely related to mutual inductance M, and both the system current Iᵢₙ and Iₒᵤₜ and power Pᵢₙ and Pₒᵤₜ are inversely proportional to mutual inductance M, which typically causes three drawbacks.

First, when mutual inductance M reduces with the misalignment, system power and current increase, and overcurrent and overpower may be triggered at a weak coupling condition. Second, in the worst case of M=0, the transmitter circuit forms a series LC resonant short-circuit, which induces an extremely high fault current in transmitter coils. Namely, the transmitter circuit cannot operate alone. Third, the conventional SS IPT system cannot work at open-circuit load conditions due to the constant-current output property, otherwise, an extremely high voltage will be induced in the secondary side, damaging the system.

To address the concerns of the conventional SS IPT system, the detuned working mode is presented, which satisfies Equation (8) below.

fₛ=f₂>f₁ EQ. 8

In this case, the secondary circuit still works in resonance condition. According to Equations (3) and (4), the input impedance Zᵢₙ is expressed as:

$${Z}_{in} = j {ω}_{s} {L}_{1} \cdot ( 1 - \frac{{f}_{1}^{2}}{{f}_{s}^{2}} ) + \frac{{( ω M )}^{2}}{{R}_{Le}} \qquad EQ . 9$$

The imaginary and real parts of Zin are defined as Zₚ and R_{M}.

$${Z}_{p} = Im ( {Z}_{in} ) = j {ω}_{s} {L}_{1} \cdot ( 1 - \frac{{f}_{1}^{2}}{{f}_{s}^{2}} ) , {R}_{M} = Re ( {Z}_{in} ) = \frac{{( ω M )}^{2}}{{R}_{Le}} \qquad EQ . 10$$

Then, the transmitting current Iᵢₙ is given as:

$${I}_{in} , = \frac{{V}_{in}}{\vert {Z}_{in} \vert} = \frac{{V}_{in}}{\sqrt{{\vert {Z}_{p} \vert}^{2} + {R}_{M}^{2}}} \qquad EQ . 11$$

At the zero coupling condition (M=0), the transmitting current achieves its peak value, given below.

$${I}_{in ( max )} = \frac{{V}_{in}}{\vert {Z}_{p} \vert} \qquad EQ . 12$$

Then system power Pᵢₙ is calculated by Equation (13) below.

$${P}_{in} = {I}_{in}^{2} {R}_{M} = \frac{{V}_{in}^{2}}{{\vert {Z}_{p} \vert}^{2} / {R}_{M} + {R}_{M}} \qquad EQ . 13$$

When R_{M}=|Z_{P}| is satisfied, the system power achieves its maximum value Pin(max), given below.

$${P}_{out ( max )} = \frac{{V}_{in}^{2}}{2 \vert {Z}_{p} \vert} ( {R}_{M} = \vert {Z}_{p} \vert ) \qquad EQ . 14$$

Equations (12) and (14) indicate that in the exemplary IPT system, Zₚ can effectively limit the system current at the zero coupling condition, and determine the maximum power of the IPT system, achieving overcurrent and overpower protection.

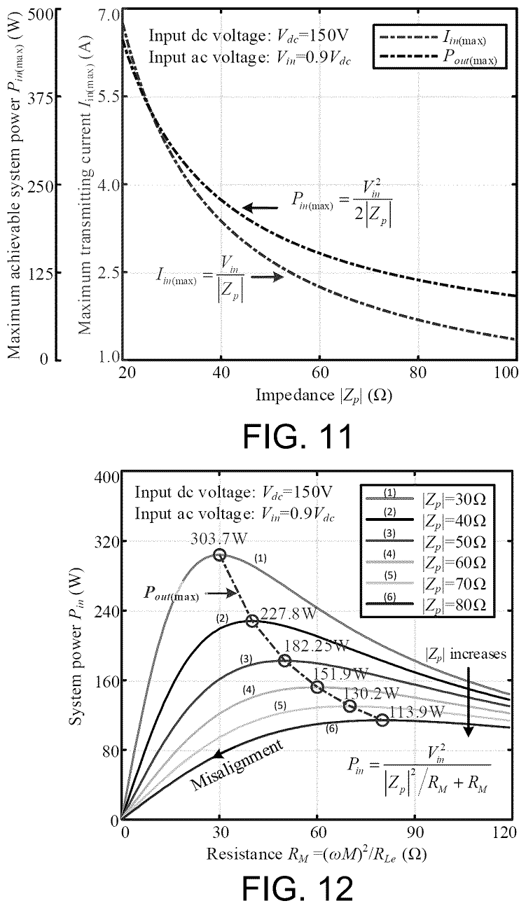

With an input DC voltage of 150V, FIG. 11 shows the maximum achievable system current and power versus different |Z_{P}|. With a specific |Z_{P}|, the output power Pₒᵤₜ versus R_{M} is provided in FIG. 12, which shows that increasing |Z_{P}| helps reduce the power fluctuation, namely high misalignment tolerance, and that a large |Z_{P}| also lower w the power transfer capability, which should be taken into design consideration.

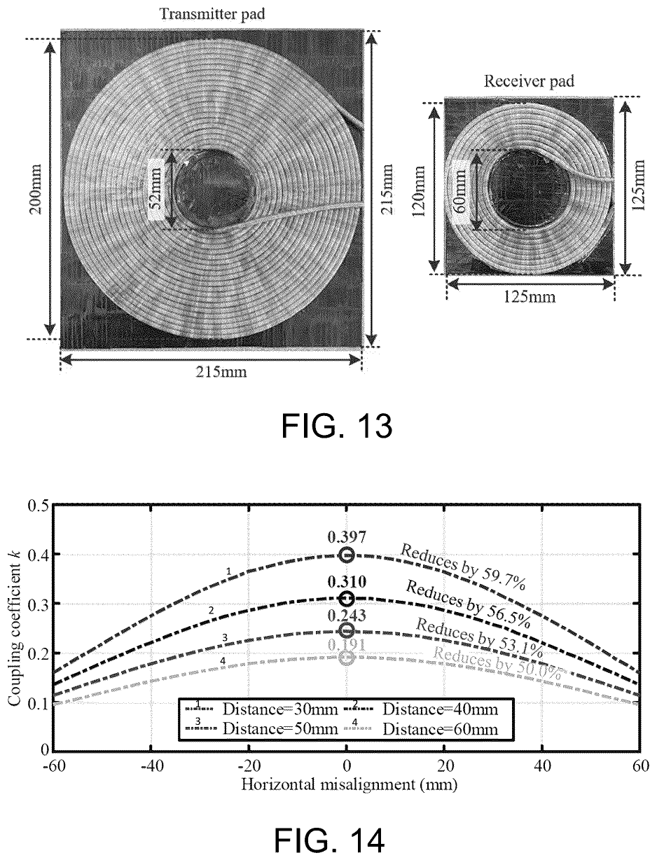

Due to the limited space in the manta ray robot, a small-size receiver may be preferred in certain embodiments. Meantime, a relatively large transmitter could be implemented to achieve high misalignment tolerance and a large effective charging region. FIG. 13 shows the implemented magnetic coupler prototype. The transmitter pad comprises a 215 mm×215 mm ferrite substrate and circular coils with a diameter of 200 mm. The receiver pad has an outer size of 125 mm×125 mm of ferrite substrate and the circular coils have a diameter of 120 mm. 3000-strand 0.04 mm Litz wire is used to fabricate the coils. The implemented transmitter and receiver coils respectively achieve 85.1 μH and 14.1 μH.

With a given transfer distance, the simulated coupling coefficient k versus different horizontal misalignments is provided in FIG. 14. Here, the figure shows that the coupler has a smaller fluctuation of k versus horizontal misalignment at a larger transfer distance. Considering the practical scenario, the nominal transfer distance is set at 50 mm, in which the coupling coefficient k achieves 0.243 in the aligned case and reduces by 53.1% with a horizontal misalignment range of [−60 mm 60 mm].

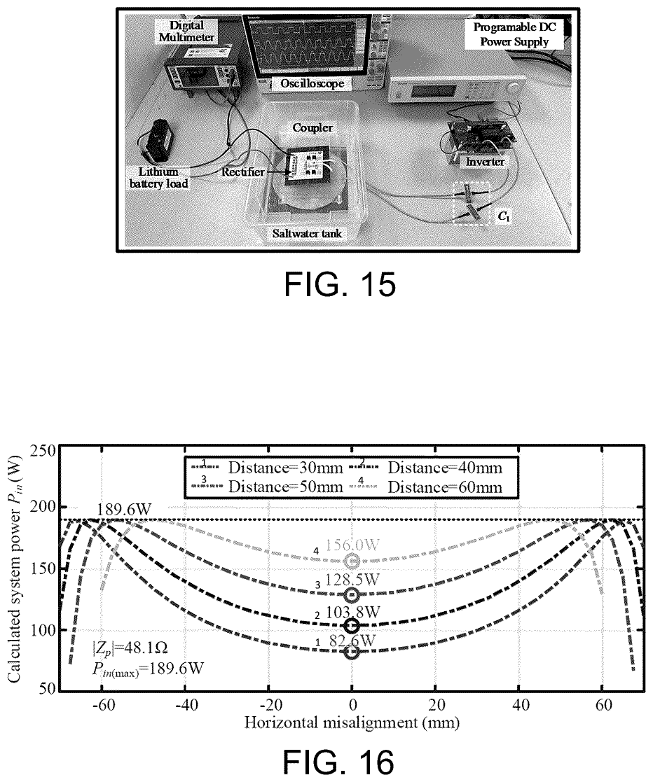

FIG. 15 shows the implemented IPT prototype under saltwater, and the system parameters are provided in Table I. The system is tested with an input DC voltage of 150V and a 4-series-3-parallel (4S3P) 7800 mAh 18650 lithium battery load with a nominal voltage of 14.8V. A silicon carbide (SiC) inverter is designed with C3M0060065K to generate a 250 kHz excitation. A rectifier is constructed by low-voltage Schottky diode DSSK48-003BS. The implemented magnetic coupler is merged into saltwater with a salinity of 35‰, which is consistent with the seawater. The aligned transfer distance is 50 mm with a coupling coefficient k of 0.243.

In this system, the primary resonant frequency f₁ is set at 200 kHz. With an operating frequency of 250 kHz, impedance |Z_{P}| achieves 48.10. According to Equation (14), the maximum achievable power of the implemented IPT system is calculated as 189.6 W. Based on the simulated coupling coefficient k at different misalignments, the calculated system power versus horizontal misalignment is provided in FIG. 16. Particularly, with a nominal transfer distance of 50 mm and a horizontal misalignment ranging [−60 mm 60 mm], the coupling coefficient k reduces by 53.1%, which will cause a power increase of 113% in traditional SS IPT system. However, in the implemented detuned SS IPT system, according to the calculation, the power only increases by 47.6% from 128.5 W to 189.6 W, showing a better misalignment tolerance.

TABLE I

| Parameter | Value | | Parameter | Value | |
|---|---|---|---|---|---|
| Input V_{dc} | 150 | V | Load battery | 14.6 V~15.5 V | |
| MOSFET | C3M0060065K | | Rectifier | DSSK48-003BS | |
| fₛ | 250 | kHz | Salinity | 35‰ | |
| Distance (aligned) | 5 | cm | k (aligned) | 0.243 | |
| f₁ | 200 | kHz | f₂ | 250 | kHz |
| L₁ | 85.1 | μH | C₁ | 7.58 | nF |
| L₂ | 14.1 | μH | C₂ | 27.6 | nF |

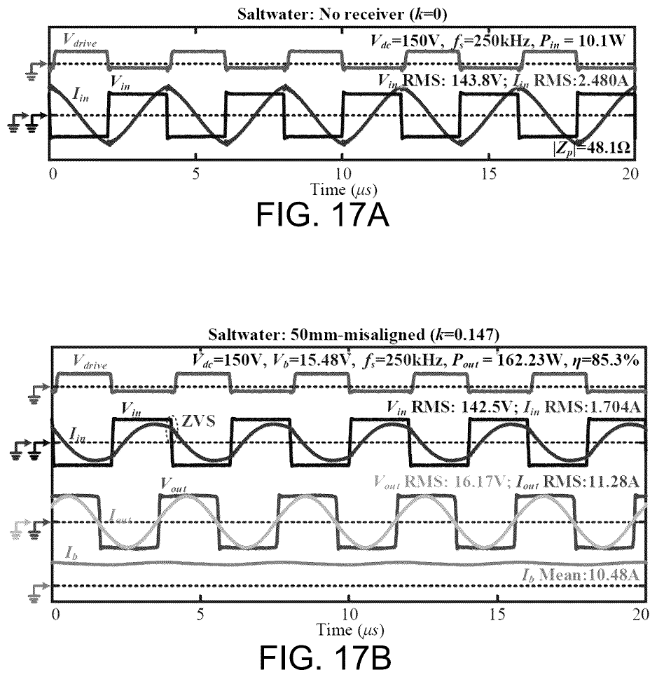

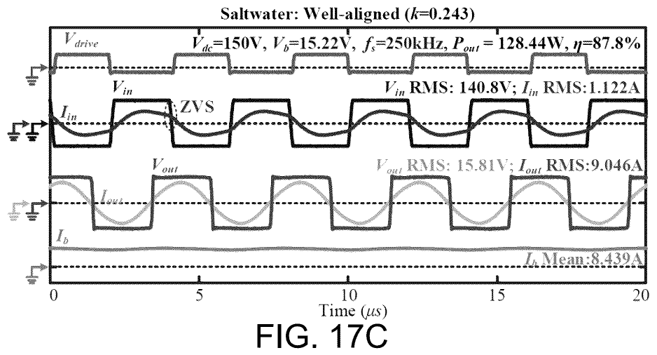

With V_{dc}=150 V, fₛ=250 kHz, and a battery load of 14.6V~15.5V, the performance of the implemented IPT system is investigated in air and saltwater. FIG. 17A shows the experimental waveforms when the receiver does not exist, namely k=0. Due to an inductive impedance Zₚ of around 48.10, the input current is limited at 2.48 A with a triangular shape and lags the input voltage by 90° in phase. In this case, this system avoids the short-circuit fault of a conventional SS IPT system at k=0, and the system power loss only achieves 10.1 W.

With a vertical transfer distance of 50 mm, FIGS. 17B-17C respectively show the experimental waveforms at horizontally 50 mm-misaligned and well-aligned cases. As the coupling coefficient increases, the input current gradually changes from triangular to sinusoidal wave, and the phase difference from the input voltage also reduces, meaning suppressed input reactive power.

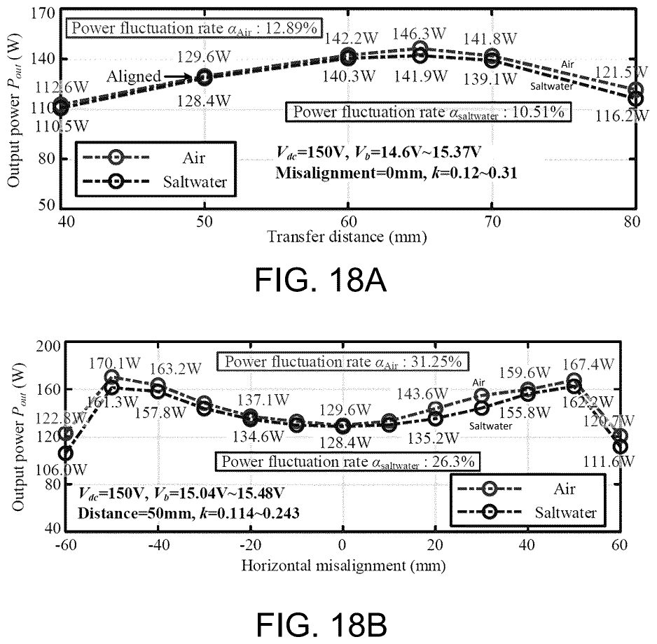

FIGS. 18A-18B show the measured output power of the implemented IPT system in air and saltwater with different vertical transfer distances. When the transfer distance increase from 40 mm to 80 mm, the coupling coefficient k reduces from 0.31 to 0.12. The measured system first increases and then reduces. The maximum output power is achieved at a transfer distance of 65 mm with 146.3 W and 141.9 W in air and saltwater, respectively. When the IPT system works in saltwater, the system output power is slightly lower than that in air, which is attributed to the increased circuit parasitic resistance caused by saltwater.

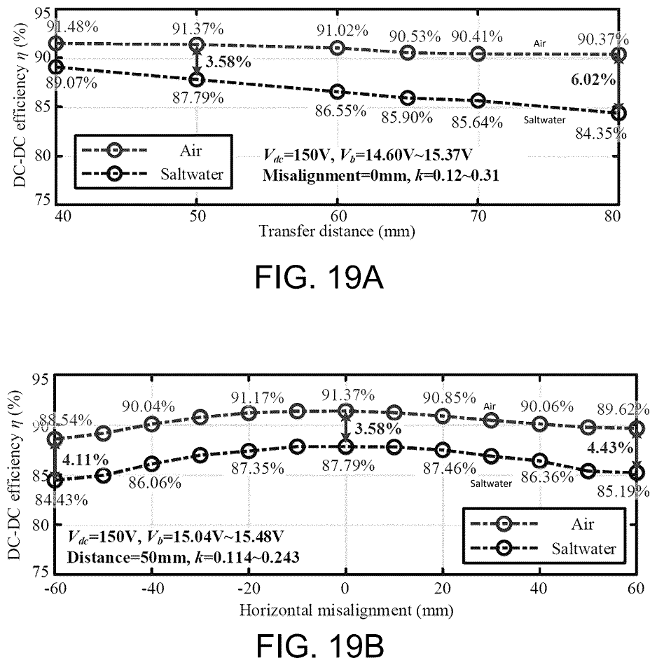

FIGS. 19A-19B show the system output power versus horizontal misalignment at a given transfer distance of 50 mm. In the aligned case, the system power respectively achieves 128.4 W in saltwater and 129.6 W in air, which is consistent with the theoretical calculation of 128.5 W shown in FIG. 16. With the horizontal misalignment, the output power gradually increases and achieves its peaks at a misalignment of ±50 mm before it starts to drop, which also agrees with FIG. 16. The maximum output power in air and saltwater respectively reaches 170.1 W and 162.2 W. Considering the system power loss, the total system input power achieves its peak of 190.9 W in air and 190.1 W in saltwater, which is consistent with the theoretical calculation of 189.6 W. It indicates that in the exemplary detuned SS IPT system, the overcurrent and overpower protection is realized as the misalignment occurs. To evaluate the impact of the misalignment on system output power, the power fluctuation rate a is defined below:

$$α = \frac{max ( \vert {P}_{out} - {P}_{out ( aligned )} \vert )}{{P}_{out ( aligned )}} \qquad EQ . 15$$

According to Equation (15), with the transfer distance ranging from 40 mm to 80 mm, the power fluctuation rate in air and saltwater respectively achieves 12.89% and 10.51%. Furthermore, with horizontal misalignment of [−60 mm 60 mm], the power fluctuation rate in air and saltwater is 31.25% and 26.3%, respectively, showing good misalignment tolerance.

Referring back to FIGS. 19A-19B, the figures provide the DC-DC efficiency of the implemented IPT measured in both air and saltwater and show that with the increase of the transfer distance and horizontal misalignment, the system efficiency experience drops due to the reduction of coupling coefficient k. Particularly, in the aligned case with a distance of 50 mm, the system achieves an efficiency of 91.37% and 87.79% in air and water, respectively. The saltwater contains plenty of ions and causes additional eddy-current loss, which accounts for the lower system efficiency in saltwater.

The figures also indicate that in saltwater the system efficiency reduces faster than that in air. Particularly, as shown in FIG. 19A, when the transfer distance increases to 80 mm, the efficiency in the air only slightly reduces to 90.37% while in saltwater, the efficiency drops to 84.35%, showing an efficiency difference of 6.02%. As shown in FIG. 19B, with a horizontal misalignment of 60 mm, the efficiency in air and saltwater respectively decrease to 89.62% and 85.19% with a difference of 4.43%.

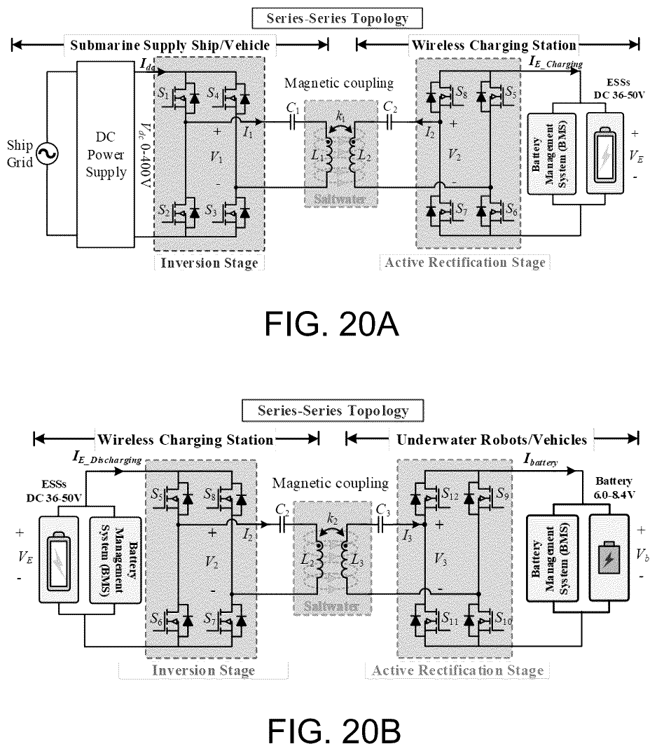

Thus, an exemplary wireless charging station can be configured based on a Series-Series (SS+SS) circuit topology, as discussed above, and also represented in FIGS. 20A-20B. Here, FIGS. 20A-20B show the wireless charging circuit configuration of SS+SS, where FIG. 20A depicts an SS wireless charging circuit from the submarine supply ship to the wireless charging station, and FIG. 20B depicts the SS wireless charging circuit from the charging station to underwater robots/vehicles. Both wireless charging stages are designed based on Series-Series circuit topologies. For each transmitter and receiver, only a series compensation capacitor is used, which achieves a high circuit simplicity.

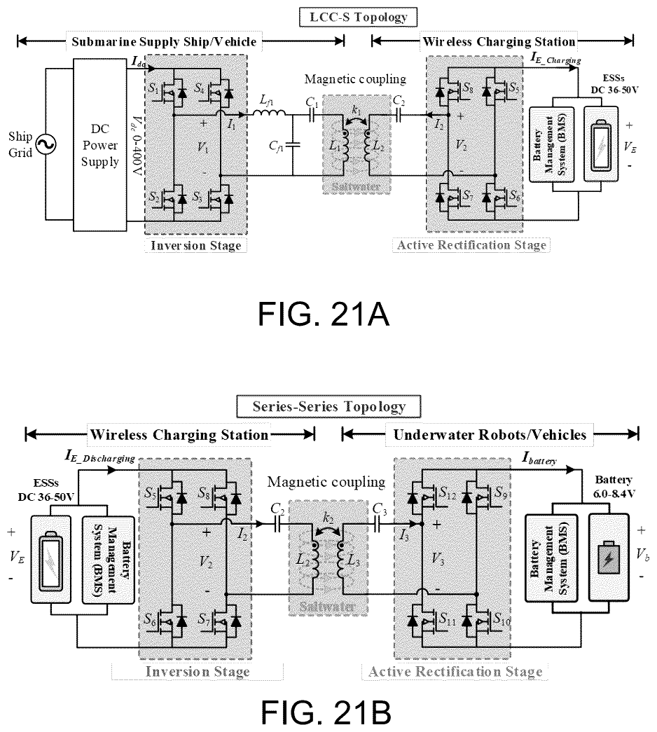

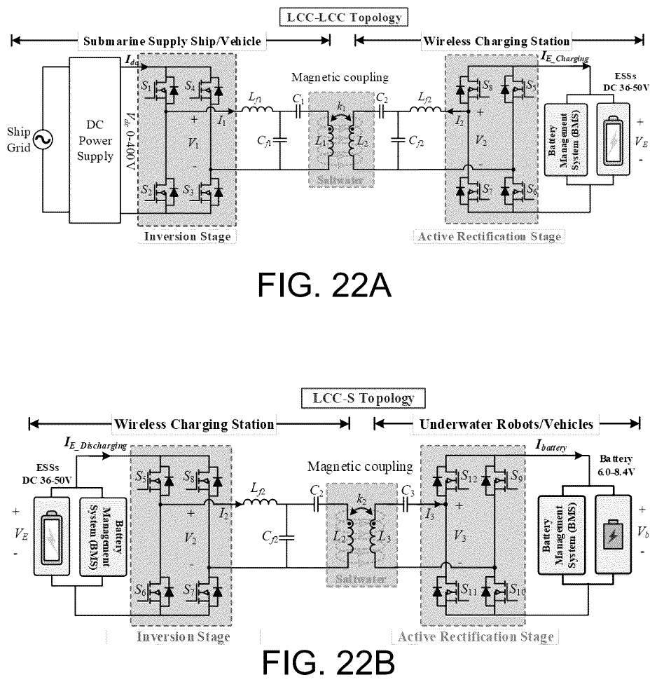

In addition to the series-series (SS) configuration, various embodiments of the present disclosure offer different wireless charging circuit configurations that include LCC-LCC and LCC-S compensations. Accordingly, FIGS. 21A-21B show the wireless charging circuit configuration of LCC-S+SS, where FIG. 21A depicts an LCC-S wireless charging circuit from the submarine supply ship to the wireless charging station and FIG. 21B depicts an SS wireless charging circuit from the charging station to underwater robots/vehicles. In the submarine supply ship, an LCC network, consisting of L_{f1}, C_{f1}, and C₁, is used to compensate the transmitter L₁, while the transmitters and receivers of wireless charging stations and underwater robots/vehicles still adopt the series-capacitor compensation. The LCC network achieves constant transmitting current and avoids overcurrent and risk in transmitter L₁ of the submarine ship when coupling coefficient k₁ is weak. Next, FIGS. 22A-22B show the wireless charging circuit configuration of LCC-LCC+LCC-S, where FIG. 22A depicts an LCC-LCC wireless charging circuit from the submarine supply ship to the wireless charging station and FIG. 22B depicts an LCC-S wireless charging circuit from the charging station to the underwater robots/vehicles. The LCC compensation network is used in both the submarine supply ship and the wireless charging station, which achieves constant current in transmitter L₁ and transmitter/receiver L₂. This configuration can avoid overcurrent risk in both transmitters of L₁ and L₂ when coupling coefficients k₁ and k₂ are weak. The receivers of underwater robots/vehicles only use the simple series capacitor compensation for compactness.

In brief, Inductive power transfer (IPT) technology is becoming a convenient and promising charging solution for underwater vehicles and robots. The conventional resonant SS IPT system potentially has overcurrent and overpower issues at weak magnetic coupling conditions. In one embodiment, the present disclosure presents an SS IPT system with a detuned transmitter circuit, which limits the transmitting current and system power at weak and even zero coupling conditions and achieves a high misalignment tolerance with stable output power. A detuned SS IPT prototype may be implemented with a switching frequency of 250 KHz and a primary resonant frequency of 200 kHz. The system performance is tested in both air and saltwater with an input DC voltage of 150V and a 14.8V lithium battery load. Experimental results show that the maximum transmitting current only achieves 2.48 A with a low power loss of 10.1 W at zero coupling condition and the maximum achievable system power is limited at 190 W. With a transfer distance of 50 mm and a horizontal misalignment range of [−60 mm 60 mm], the output power has a small fluctuation of 31.25% and 26.3% in air and saltwater, respectively. In the aligned condition, the maximum system efficiency achieves 91.37% with 129.6 W in air and 87.79% with 128.4 W in saltwater.

Different wireless charging circuit configurations may be deployed that include LCC-LCC and LCC-S compensations. As such, the present disclosure provides improved underwater wireless charging systems and methods that do not require underwater vehicles/robots/machines to be recovered or removed from an underwater environment before undergoing a wireless charging operation. The disclosed wireless charging systems and related methods show compatibility with various underwater vehicles/robots/machines with varying body shapes and can simultaneously charge multiple underwater devices, which achieves safe and automatic underwater charging operations, saves intensive labor forces, and increases the working efficiency of the underwater devices.

### Embodiments

Embodiment 1. A wireless charging system comprising: a wireless charging station installed on a seafloor, wherein the wireless charging station is equipped with a plurality of wireless transmitter coils that are powered by an energy storage system configured to wirelessly transfer power between a respective one of the plurality of wireless transmitter coils and a wireless receiver coil of an underwater device.

Embodiment 2. The wireless charging system of embodiment 1, wherein the plurality of wireless transmitter coils include at least one planar transmitter coil and at least one cylindrical transmitter coil.

Embodiment 3. The wireless charging system of embodiment 1, wherein the underwater device comprises an underwater robot or an underwater vehicle.

Embodiment 4. The wireless charging system of embodiment 1, wherein the wireless charging station is configured to deploy a series-series (SS) wireless charging circuit to transfer power from the wireless charging station to the underwater device.

Embodiment 5. The wireless charging system of embodiment 4, wherein the series-series wireless charging circuit has a switching frequency of 250 kHz and a primary resonant frequency of 200 kHz.

Embodiment 6. The wireless charging system of embodiment 1, wherein the wireless charging station is configured to deploy an inductor-capacitor-capacitor-series (LCC-S) wireless charging circuit to transfer power from the wireless charging station to the underwater device.

Embodiment 7. The wireless charging system of embodiment 1, wherein the energy storage system is configured to be recharged by a submarine ship, wherein at least one of the plurality of wireless transmitter coils is configured to receive a transfer of power from the submarine ship.

Embodiment 8. The wireless charging system of embodiment 7, wherein the wireless charging station is configured to deploy a series-series (SS) wireless charging circuit to transfer power between the submarine ship to the wireless charging station.

Embodiment 9. The wireless charging system of embodiment 8, wherein the wireless charging station is configured to deploy a series-series (SS) wireless charging circuit to transfer power from the wireless charging station to the underwater device.

Embodiment 10. The wireless charging system of embodiment 7, wherein the wireless charging station is configured to deploy an inductor-capacitor-capacitor-series (LCC-S) wireless charging circuit to transfer between the submarine ship to the wireless charging station.

Embodiment 11. The wireless charging system of embodiment 10, wherein the wireless charging station is configured to deploy a series-series (SS) wireless charging circuit to transfer power from the wireless charging station to the underwater device.

Embodiment 12. The wireless charging system of embodiment 7, wherein the wireless charging station is configured to deploy an LCC-LCC wireless charging circuit to transfer between the submarine ship to the wireless charging station, where L denotes an inductor element and C denotes a capacitor element.

Embodiment 13. The wireless charging system of embodiment 12, wherein the wireless charging station is configured to deploy an inductor-capacitor-capacitor-series (LCC-S) wireless charging circuit to transfer power from the wireless charging station to the underwater device.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the present disclosure. All such modifications and variations are intended to be included herein within the scope of this disclosure.

Unless defined otherwise, all technical and scientific terms used herein have the same meanings as commonly understood by one of skill in the art to which the disclosed invention belongs. Those skilled in the art will recognize, or be able to ascertain using no more than routine experimentation, many equivalents to the specific embodiments of the present disclosure described herein. Such equivalents are intended to be encompassed by the following claims.

We claim:

1. A wireless charging system comprising:
a wireless charging station installed on a seafloor, wherein the wireless charging station is equipped with a plurality of wireless transmitter coils that are powered by an energy storage system configured to wirelessly transfer power between a respective one of the plurality of wireless transmitter coils and a wireless receiver coil of an underwater device.

2. The wireless charging system of claim 1, wherein the plurality of wireless transmitter coils include at least one planar transmitter coil and at least one cylindrical transmitter coil.

3. The wireless charging system of claim 1, wherein the underwater device comprises an underwater robot or an underwater vehicle.

4. The wireless charging system of claim 1, wherein the wireless charging station is configured to deploy a series-series (SS) wireless charging circuit to transfer power from the wireless charging station to the underwater device.

5. The wireless charging system of claim 4, wherein the series-series wireless charging circuit has a switching frequency of 250 kHz and a primary resonant frequency of 200 KHz.

6. The wireless charging system of claim 1, wherein the wireless charging station is configured to deploy an inductor-capacitor-capacitor-series (LCC-S) wireless charging circuit to transfer power from the wireless charging station to the underwater device.

7. The wireless charging system of claim 1, wherein the energy storage system is configured to be recharged by a submarine ship, wherein at least one of the plurality of wireless transmitter coils is configured to receive a transfer of power from the submarine ship.

8. The wireless charging system of claim 7, wherein the wireless charging station is configured to deploy a series-series (SS) wireless charging circuit to transfer power between the submarine ship to the wireless charging station.

9. The wireless charging system of claim 8, wherein the wireless charging station is configured to deploy a series-series (SS) wireless charging circuit to transfer power from the wireless charging station to the underwater device.

10. The wireless charging system of claim 7, wherein the wireless charging station is configured to deploy an inductor-capacitor-capacitor-series (LCC-S) wireless charging circuit to transfer between the submarine ship to the wireless charging station.

11. The wireless charging system of claim 10, wherein the wireless charging station is configured to deploy a series-series (SS) wireless charging circuit to transfer power from the wireless charging station to the underwater device.

12. The wireless charging system of claim 7, wherein the wireless charging station is configured to deploy an LCC-LCC wireless charging circuit to transfer between the submarine ship to the wireless charging station, where L denotes an inductor element and C denotes a capacitor element.

13. The wireless charging system of claim 12, wherein the wireless charging station is configured to deploy an inductor-capacitor-capacitor-series (LCC-S) wireless charging circuit to transfer power from the wireless charging station to the underwater device.
